(19) United States
(12) Patent Application Publication
(10) Pub. No.: US 2006/0015709 A1
(43) Pub. Date: Jan. 19, 2006

(54) Reconfigurable state machine architecture and related method of execution

(76) Inventors: Andrea Bragagnini, Torino (IT); Maura Turolla, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/533,400

(22) PCT Filed: Oct. 24, 2002
(86) PCT No.: PCT/EP02/11903

§ 371 Date: Apr. 25, 2005

(51) Int. Cl. G06F 9/00

(52) U.S. Cl. 712/245

(57) ABSTRACT

An architecture for a state machine (10) with a number of states of the machine, comprises a memory (14) having a set of addresses. The memory (14) is arranged to store at each of said addresses in the set the complete description of a respective one of said number of states of the machine (10).

### FIELD OF THE INVENTION

The invention relates to state machines and, more specifically, to architectures for state machines.

### DESCRIPTION OF THE RELATED ART

Evolution of microelectronics has led to highly complex components being integrated in a single circuit, thus giving rise to so-called systems-on-a-chip (SoC). Complex systems including co-operating hardware and software components can thus be manufactured that implement high-level functions.

Key features of a truly successful electronic system are reconfigurability and the capability of programming, possibly in run time conditions, the functions performed by a single integrated circuit. These features provide the circuit with a high degree of flexibility, while permitting the circuit to be used for different applications.

The concept of programmability has been applied to microprocessors, where binary instructions are translated into a set of micro-instructions (that are fixed within the processor) for controlling operations in the operating part of the processor, i.e. that part of the processor where “active” elements such as adders, multipliers, and so on are located. A first extension of this concept leads to re-programming the microinstruction set in order to extend the set of instructions adapted to be implemented by the processor. For that purpose, specialised hardware blocks may be associated with the processor in order to perform those functions whose degree of complexity is beyond the current capability of a microprocessor and/or those functions not adapted to be implemented in a truly satisfactory manner by a microprocessor. Such hardware blocks are usually patterned after a fixed configuration and generally exhibit a poor degree of re-programmability as they are in fact designed to fulfil a specific function.

A new concept recently introduced in the art provides for programmability being extended also to those hardware blocks. To obtain this, the control parts that manage operation of the data portion of the processor must be suitable for re-programming. Such control parts are currently implemented via a finite state machine or FSM.

In U.S. Pat. No. 6,212,625 a general-purpose dynamically programmable state engine is disclosed that dynamically executes finite state machine and finite state machine models. The state engine comprises an input and filter unit, a storage unit, a transition unit, and an action generation unit. The storage unit stores a state entry table including a plurality of state entries. Each state entry in the storage unit includes a state identifier, a symbol identifier, a plurality of state attributes, and a next state. The input and filter unit accepts inputs and translates the inputs to symbols. The symbols are provided to the transition unit. The transition unit maintains a current state and locates a state entry in the storage unit having a state identifier matching the current state and a symbol identifier matching a current symbol. The current state is set to a next state of a matching entry by the transition unit when the matching entry is a terminating entry. When a terminating entry is detected, an action generation unit for processing the terminating entry is activated. A finite state machine may be configured for execution by the state engine using a state machine development tool.

The arrangement disclosed in U.S. Pat. No. 6,212,625 provides for a state entry table including cells (i.e. addresses) each associating a single next state to a given state identifier. Information related to possible evolution of the machine from a given state towards a plurality of next states, that is a current occurrence in state machines, can thus be stored only in a corresponding plurality of cells. Properly executing such a state machine requires that all these cells should be read, which inevitably takes a corresponding plurality of clock cycles, thus slowing down machine execution.

Another basic disadvantage of the arrangement of U.S. Pat. No. 6,212,625 lies in that reprogramming of the storage unit comprising the core of the state engine disclosed therein can only be effected via the transition unit associated therewith, that is through the input data channel to the transition unit and the state machine.

### OBJECT AND SUMMARY OF THE INVENTION

The object of the present invention is to provide an improved arrangement that dispenses with the drawbacks of the prior art arrangement considered in the foregoing.

According to the invention, that object is achieved by means of the state machine architecture having the features set forth in the claims that follow. The invention also relates to a corresponding method of executing such a state machine.

In the presently preferred embodiment, the invention provides a re-programmable state machine architecture adapted to be implemented by means of volatile memories.

A presently preferred use of the architecture of the present invention is within control units for interface adapted for interfacing buses and intellectual properties (IPs). However, reference to such a possible application is for exemplary purposes only and must in no way be construed as limiting the scope of the invention.

The architecture of the invention is adapted for VHDL description at the system level and is therefore technology-independent. In comparison with prior art solutions, the architecture of the invention has a parametric nature and can be easily adapted to different configurations. The parametric nature also facilitates implementation of optimal solutions concerning chip area, particularly in respect of the use of memories.

In the presently preferred embodiment, the main parameters adapted to be selectively varied are:

the maximum number of states;

the maximum number of transitions from one state towards the other states (or the same state);

the type of machine description, that is Mealy or Moore; and

the number of counters used for describing the state machine.

As is well known, in a Mealy machine the output is determined by the inputs and the current state. Conversely, in a Moore machine the output is determined only by the current state while the inputs affect only the state transitions. The parameters mentioned in the foregoing thus have an impact on overall RAM size.

Counters can be used for following a number of times a path through a state or a series of states. In comparison with prior art solutions counters are implemented externally of the machine and communicate with the machine via an enable signal and an end of count signal. Such signals are therefore handled as current input and output signals of the state machine. The description of the machine to be stored in the memory (typically a RAM) can be appreciably reduced, thus achieving a significant reduction in memory occupation. Programmability is ensured by making the reference value (or the end count value) of the counters adapted to be modified, possibly in run time conditions. To that end each counter is provided with a re-writable register containing the reference value. This concept can be easily extended to other computational blocks such as adders and comparators.

### BRIEF DESCRIPTION OF THE ANNEXED DRAWINGS

The invention will now be described, by way of example only, with reference to the annexed figures of drawing, wherein:

FIG. 1 is a block diagram showing the general layout of an architecture according to the invention,

FIG. 2 describes the overall arrangement of the memory within the architecture of FIG. 1,

FIG. 3 is diagram further detailing organisation and arrangement of the memory of an architecture according to the invention, and

FIGS. 4 and 5 are exemplary of the time behaviours of certain signals generated within the architecture of the invention.

### DETAILED DESCRIPTION OF A PREFERRED EMBODIMENT OF THE INVENTION

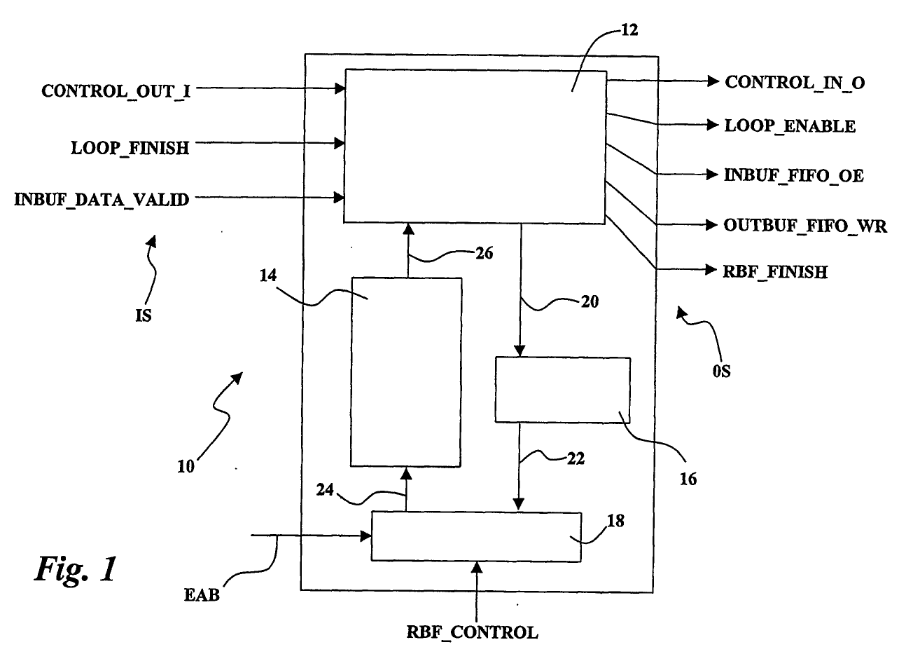

In the block diagram of FIG. 1 a finite state machine (FSM) architecture according to the invention is generally designated 10.

More specifically, the exemplary embodiment shown in FIG. 1 relates to a RAM based FSM (hereinafter RBF) including the following basic blocks:

an output and state selector 12, the selector 12 being fed with input signals IS and adapted to generate therefrom output signals OS;

a basic memory block 14, in the form of a RAM;

a state register 16; and

a controller 18 operating under the control of a control signal RBF_CONTROL in co-operation with an external access bus over a line designated EAB.

Information concerning the states is transferred from the selector 12 towards the state register 16 over a line 20 thus permitting corresponding information to be transferred from the register 16 to the controller 18 over a line 22. Control signals generated within the controller 18 are transferred towards the RAM 14 over a line 24 while a line 26 carries signals generated within the RAM 14 towards the selector 12.

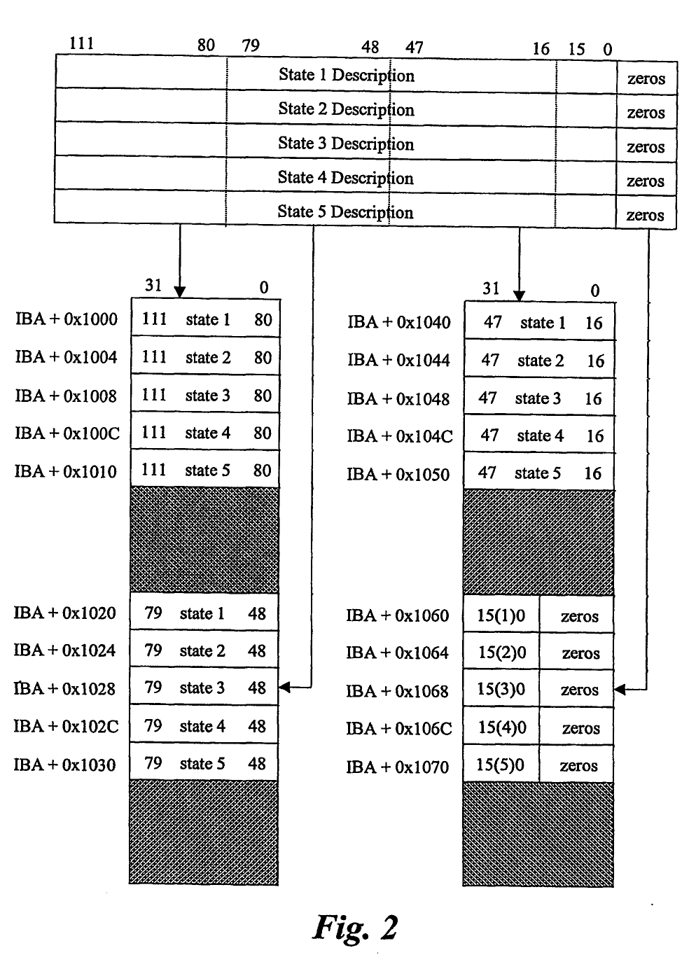

As better shown in FIG. 2, the memory 14 is arranged in such a way to permit transition from a state to another within a single cycle of the respective clock signal CLK. In order to achieve this, the complete description of a state must be available at the same instant of time. Since the description of each state is relatively long, a plurality of memory units are provided that are operated jointly and simultaneously selected. Each such memory unit contains a respective portion of the description of the state.

One and only one state is associated to each address in the RAM memory. For instance, all of the 0x0000 addresses of the RAM units include a part of the description of state 0. The contents of the addresses 0x0000 of the various RAM units thus jointly and completely describe state 0.

This solution is an improvement over prior art arrangements wherein a single branch of the graph representing the state machine is stored in each memory cell (memory address). The arrangement described herein requires several memory units, but this does not represent a disadvantage since present-day technologies (especially FPGA) provide memories having the degree of flexibility required for that purpose. On the other hand, a significant advantage related to the arrangement described here lies in the state diagram of the machine being run through very rapidly. The various memories are mapped on a single address plain with the 32 bit memory cells as shown in FIG. 2.

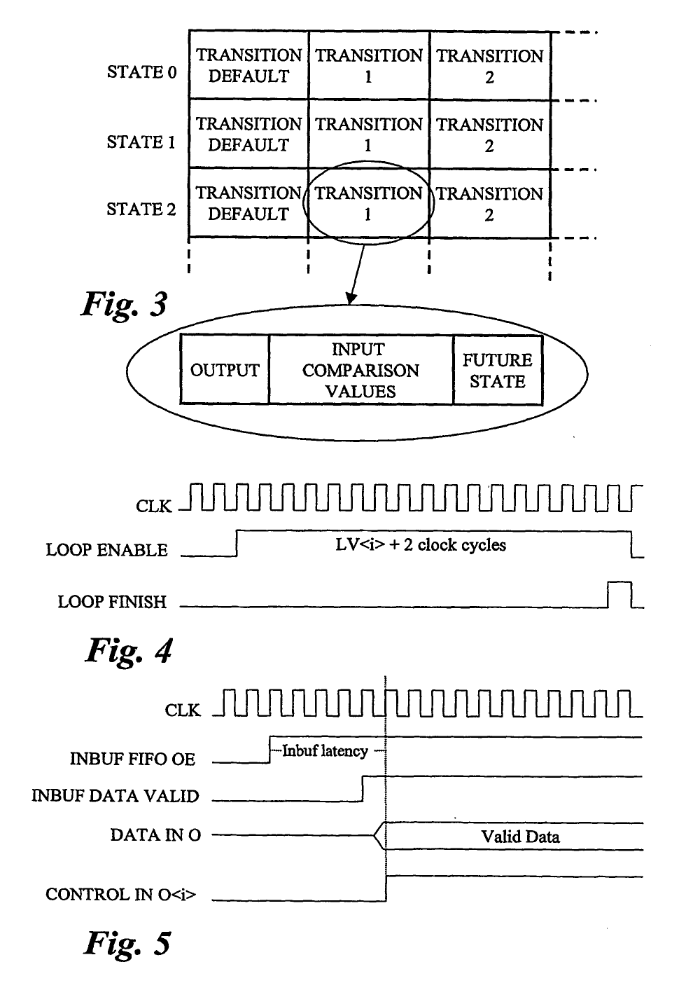

The description of a single state is partitioned in different sections, each of which describes the possible transition from that state towards another state (see FIG. 3). Each transition is described in terms of conditions on the machine input, value of the subsequent state and values that the machine output must take on (this last-mentioned value being required only in the case of a Mealy machine).

There is one bit for each machine output that can be set to 1 or 0. The next state is expressed in binary format and used for re-addressing the memory.

Input conditions are expressed by means of two bits for each input. In that way the condition to be expressed can be set as input=1, input=0 or input=X, that is as a three state value. This represents an improvement over prior art solutions that include conversion functions to pass from the input configuration to configurations typical of the state machine.

A default transition is also provided including only the next state and the output values. This transition is selected if none of the input condition on the other transition inputs is met. In the case of in an implementation in the form of a Moore machine to each transition there is associated the output value of the default transition.

By referring again to the block diagram of FIG. 1 the state register 16 contains the present state and is adapted to re-address the memory 14.

The controller 18 manages accesses to the RAM 14 and, more generally, operation of the RBF 10.

During normal operation, the controller 18 causes the value of the state register 16 to address the memory 14.

Following a request from outside (RBF_CONTROL), the controller 18 can standby, reset or pause the RBF flow. These controls ensure a high degree of flexibility without making the architecture unduly complicated.

The controller 18 is adapted to manage re-programming of the RBF 10 in a situation where the memory 14 is no longer addressed by resorting to the state register 16, but is completely controlled from outside.

Specifically, upon receiving a re-programming command (RBF_CONTROL), the controller 18 can standby the RBF 10 and “open” the loop that during normal operation causes the value of the state register 16 to address the memory 14.

At this point, the memory is no longer addressed by the state register 16 but is set to a condition where the contents of the memory 14 can be modified, to effect the desired reprogramming function, on the basis of reprogramming signals received over the EAB line, that is from outside the state machine.

Also, the controller 18 can act on the state register 16 to reset the contents thereof or cause the state register 16 to recycle through the same value to pause operation of the RBF 10.

In one embodiment of the invention, the RBF architecture 10 is organised around the RAM memory 14 with few addresses and long words. Each memory address corresponds to a state and the address content describes the state. When a state is selected, the state description is combined with the input to determine the next state and the output. The RBF flow can be started, paused and reset through external signals (RBF_CONTROL).

FIG. 1 lists all the inputs and outputs in connection with possible use of the RBF 10 within a control unit for an interface for interfacing via respective buffers (not shown) a bus and an Intellectual Property (IP).

Specifically, CONTROL_OUT_I indicates a signal representative of the inputs controlling operation of the IP. LOOP_FINISH represents the end-of-count signals of the counters associated with the RBF 10, while INBUF_DATA_VALID indicates that the output signals from the buffer from the bus to the IP are accessible (valid).

CONTROL_IN_O represents the signals from the IP, LOOP_ENABLE are the start count signals from the counters, and INBUF_FIFO_OE is the signal that activates reading of signals from the buffer from the bus to the IP. OUTBUF_FIFO_WR is the signal that activates writing of signals into the buffer from the IP to the bus. Finally, RBF_FINISH is the signal indicating that the RBF has completed running through its states.

The RBF has direct control on the IP control signals (CONTROL_IN_O and CONTROL_OUT_I). The number of these signals can be chosen via the CONTROL_IN_SIGNALS and CONTROL_OUT_SIGNALS parameters.

The signals LOOP_FINISH and LOOP_ENABLE (whose number is set with the LOOP_COUNTERS parameter) allow the RBF 10 to use external counters. To avoid expanding the RAM 14, counters are implemented outside the RBF main architecture. To enable operation of the respective counter the RBF 10 must drive high the LOOP_ENABLE signal corresponding to the suited counter until it responds driving high the LOOP_FINISH signal.

FIG. 4 shows that the LOOP_ENABLE signal must be asserted for LV<i>+2 clock cycles and also during the last cycle when LOOP_FINISH is asserted. Failing to respect this protocol may cause internal failure.

The INBUF_DATA_VALID signal is internally driven high when Inbuffer data are ready to be strobed on the IP input port after an INBUF_FIFO_OE request. The data is put on the port one cycle after the INBUF_DATA_VALID has been driven high. User can program the RBF 10 to drive one of the CONTROL_IN_0 signals as a data validation signal, after the INBUF_DATA_VALID has been driven high.

FIG. 5 shows Inbuffer data read timings. INBUF_FIFO_OE can be driven by the RBF. After a given latency the data are put on the IP input port. INBUF_DATA_VALID switches one cycle before so a validation data signal can be driven if necessary on a particular pin in the CONTROL_IN_O port.

The total amount of states is limited by the STATE_NUMBER parameter whose maximal value can be e.g. 64. This means that the RAM cannot be longer than 64 cells. The cell size can be very high, especially when there are many possible transitions from one state to the others. For that reason the user can define the maximal number of transitions from one state to the others to optimise memory usage.

This is done by setting the parameter TRANSITION_PER_STATE (whose maximal value can be e.g. equal to 7). Also, the user can choose between a Mealy and Moore implementation for the RBF 10: this may be done e.g. by means of the MEALY_NOT_MOORE parameter. The former choice requires more memory but allows more flexible programs. The latter choice normally requires more states to be defined but occupies less memory.

The following formula gives the RBF word length:
STATE_DESCRIPTION_DIM=RBF_OUTPUT+STATE_DIM+
TRANSITION_PER_STATE*(2*RBF_INPUT+STATE_DIM+MEALY_NOT_MOORE*RBF_OUTPUT)
where
RBF_OUTPUT_=CONTROL_IN_SIGNALS+LOOP_COUNTERS+3
STATE_DIM=[log2(STATE_NUMBER)]
RBF_INPUT=CONTROL_OUT_SIGNALS+LOOP_COUNTERS+1

The RBF RAM 14 is preferably implemented as a set of 32 bits word RAM accessed at the same time.

As shown in detail in FIG. 2 the binary code in RBF 10 is structured over several binary words whose lengths depend on the RBF parameters, while the number of words depends on the number of states. Nevertheless the binary code is downloaded in the RAM 14 of the RBF 10 through the 32 bit bus before running the process; for that reason the code can be reorganised on a 32 bit basis as shown in the example.

The state description is filled with zeros to reach a whole bit number that is a multiple of 32. The new word is split into several 32-bit words. The most significant words are placed at the beginning of the memory plan, empty addresses are added to align the words and then the other parts follow. Setting the STATE_NUMBER signal as a power of 2 is preferred as this avoids adding empty addresses. RBF memory organisation as shown in FIG. 2 provides for 5 states and 112 bits for each state.

An executable program automatically generates the RBF binary code as well as its memory organisation. The input to this program contains all the RBF parameters inputs as well as the state machine description. The complete format is shown hereinbelow.
#RBF PARAMETERS
CONTROL IN SIGNALS=x
CONTROL OUT SIGNALS=y
NUMBER OF STATES=s
MAX TRANSITION PER STATE=t
MEALY NOT MOORE=m
LOOP COUNTERS=1
#OUTPUT NAMES DEFINITION
0 RBF FINISH
1 OUTBUF FIFO WR O
2 INBUF FIFO OE I
3 LOOP COUNTERS ON 1
4 <ip input control signal>
5 <ip input control signal>
. . .
# INPUT NAMES DEFINITION
O INBUF DATA VALID I
1 LOOP COUNTERS FINISH <1>
2 <ip output control signal>
3 <ip output control signal>
. . .
#state <i>
cond: <input signal> <value>
<input signal> <value>
. . .
output: <output signal>1
<output signal>1
. . .
nextstate: <state number>
output: <output signal>1
nextstate: <state_number>

In the first part, the parameters are declared.

The second part contains the output signal name definitions. Then the loop counter enable signals definition is to be provided; the number of these instances may change according to the LOOP_COUNTERS value (maximum value=4). Then the IP input control signals must be declared (up to CONTROL_IN_SIGNALS value). The first signal declared is connected to the pin CONTROL_IN_SIGNALS_O (0), the second one to the pin CONTROL_IN_SIGNALS_O (1) and so on.

The third part contains the input signal names definitions. Then the loop counter finish signals must be defined; the number of these instances can change according to the LOOP_COUNTERS value (maximum value 4). Then the IP output control signals must be declared (up to CONTROL_OUT_SIGNALS value). The first signal declared is connected to the pin CONTROL_OUT_SIGNAL_I (0), the second one to the pin CONTROL_OUT_SIGNALS_I (1) and so on.

After all the definitions the RBF behaviour is described. There must be as many #state <i> instances as NUMBER_OF_STATES, with <i> varying from 0 to NUMBER_OF_STATES—1. For each state all the possible transitions are declared. Each transition declaration preferably includes three statements, namely: the condition that must be verified for the transition to occur, the output signals (for a Mealy machine) that must be set to one (the other signals will be automatically set to 0), and the next state. There can be as many transition declarations as MAX_TRANSITION_PER_STATE.

In addition to these declarations, a default transition, including the output signals and the next state, is defined to occur if all the conditions declared are not verified. If a Moore machine is implemented, the default transition output signals refer to the entire state.

A feature of the architecture described herein is the parametric nature of the selector 12. Depending on the size of the state description and the number of inputs to the selector a certain number of comparators are provided. Each comparator receives as its input all the input signals to the state machine as well as one of the possible input configurations described in the state description. If one of the comparators provides a positive result, the next state and the corresponding output are selected. Otherwise, default values are selected.

The state machine corresponding to the architecture just described can be used in different contexts and for different applications. To advantage, it can used as an integral part of the control section of hardware IPs.

Before execution by the RBF 10, the RAM 14 can be re-loaded with a new configuration. The development of the binary code for storage in the RAM 14 may be supported by a development tool that generates the binary code to be loaded into the RAM 14 starting from the conventional graphical representation of a state machine.

Of course, without prejudice to the underlying principle of the invention, the details and the embodiments may vary with respect to what has been described by way of example only without departing from the scope of the invention as defined by the claims that follow.

1. An architecture for a state machine (10) with a number of states of the machine, the architecture including a memory (14) having a set of addresses, wherein said memory is arranged to store at each of said addresses in the set the complete description of a respective one of said number of states of the machine (10).

2. The architecture of claim 1, characterised in that said memory (14) is clocked by a clock signal (CLK) and in that said memory (14) is arranged to switch from one state to another state within a single cycle of said clock signal (CLK).

3. The architecture of claim 1, characterised in that said memory (14) comprises at each address in said set a plurality of memory units adapted to be simultaneously selected to store a respective portion of said complete description of said respective one of said number of states of the machine (10).

4. The architecture of claim 3, characterised in that said plurality of memory units are mapped on an address plane with memory cells of a given length.

5. The architecture of claim 1, characterised in that said complete description of a respective one of said number of states of the machine (10) is partitioned in a number of sections, each said section describing a possible transition from said respective one state towards another state of said number of states of the machine (10).

6. The architecture of claim 1, characterised in that:
said number of states of the machine (10) are expressed as binary values, and
transitions between states of said number of states take place between a present state and a next state.

7. The architecture of claim 6, characterised in that the binary value for said next state is used to re-address said memory (14).

8. The architecture of claim 6, characterised in that it comprises a state register (16) to contain the binary value for said present state, said state register (16) being adapted to address said memory (14).

9. The architecture of claim 8, characterised in that it comprises a controller (18) to control access to said memory (14), said controller (18) being arranged to perform at least one of the functions selected from the group consisting of:
causing said memory to be addressed via said state register (16),
reset the contents of said state register (16),
causing said state register to re-cycle through the same binary value.

10. The architecture of claim 1, characterised in that it comprises a controller (18) having a respective input line (EAB) to the state machine (10), said controller (18) being arranged to selectively feed said memory (14) with re-programming signals received over said respective input line.

11. The architecture of claim 10, characterised in that it comprises an output and state selector (12) having a set of input lines (IS) to the machine (10) and in that said respective input line (EAB) to said controller (18) is distinct from said input (IS) lines of said selector (12).

12. The architecture of claim 1, characterised in that it comprises an output and state selector (12) having a set of input lines (IS) to the machine (10) and in that said selector (12) comprises at least one line in said set of input lines (IS) adapted to receive input signals as two bit condition signals whereby said condition can be expressed as a three state signal (1,0,X).

13. The architecture of claim 6, characterised in that a default transition is provided among states of said number of states, said default transition including said next state as well as the values of said output signals (OS).

14. The architecture of claim 13, characterised in that said machine (10) is arranged to select said default transition when none of the conditions on the inputs of the other transitions is met.

15. The architecture of claim 13, characterised in that said machine (10) is a Moore machine and in that to each said transition there correspond the output values of said default transition.

16. The architecture of claim 6, characterised in that it comprises an output and state selector (12) having a set of input lines (IS) to the machine (10), said selector (12) including a plurality of comparators, each of said comparators being adapted to receive over said set of input lines (IS) input signals as well as one of the possible input configurations described in the state description; said selector (12) being arranged to select a next state of said number of states as well as the corresponding set of output signals (OS) if one of said comparators provides a positive result, default values being selected in the absence of any such positive result.

17. The architecture of claim 1, characterised in that it comprises a plurality of counters for describing the state machine (10), said counters being provided as external components of said state machine (10), said counters being arranged to communicate with the said state machine (10) by means of at least one of an enable signal and an end-of-count signal.

18. The architecture of claim 1, characterised in that it comprises at least one computational block external with respect to said state machine (10), said at least computational block being arranged to communicate with said state machine (10) by means of at least one signal selected from the group consisting of the signals input to the machine (IS) and the signals output from the machine (OS).

19. The architecture of claim 17, characterised in that said counters have at least one of a reference value and an end-of-count value, said counters being arranged so that said at least one of said reference value and said end-of-count value can be modified run time.

20. The architecture of claim 17, characterised in that said counters comprise at least one re-writable register adapted to contain a reference value for the respective counter.

21. The architecture of claim 1, characterised in that said memory (14) is a random access memory (RAM).

22. A method of executing a state machine (10) with a number of states of the machine, the method including the steps of:
providing a memory (14) having a set of addresses, and
storing at each of said addresses in the set the complete description of a respective one of said number of states of the machine (10).

23. The method of claim 22, characterised in that it comprises the steps of clocking said memory (14) by a clock signal (CLK) and switching said memory (14) from one state to another state within a single cycle of said clock signal (CLK).

24. The method of claim 22, characterised in that it comprises the steps of:
providing at each address in said set a plurality of memory units,
simultaneously selecting said plurality of memory units to store a respective portion of said complete description of said respective one of said number of states of the machine (10).

25. The method of claim 24, characterised in that it comprises the step of mapping said plurality of memory units on an address plane with memory cells of a given length.

26. The method of claim 22, characterised in that it comprises the step of partitioning said complete description of a respective one of said number of states of the machine (10) in a number of sections, each said section describing a possible transition from said respective one state towards another state of said number of states of the machine (10).

27. The method of claim 22, characterised in that it comprises the steps of:
expressing said number of states of the machine (10) as binary values, and
causing said transitions between states of said number of states to take place between a present state and a next state.

28. The method of claim 27, characterised in that it comprises the step of using the binary value for said next state to re-address said memory (14).

29. The method of claim 27, characterised in that it comprises the steps of providing a state register (16) containing the binary value for said present state, said state register (16) being adapted to address said memory (14).

30. The method of claim 29, characterised in that it comprises the step of controlling (18) access to said memory (14) by performing at least one of the functions selected from the group consisting of:
causing said memory to be addressed via said state register (16),
reset the contents of said state register (16),
causing said state register to re-cycle through the same binary value.

31. The method of claim 22, characterised in that it comprises the steps of:
providing a a respective input line (EAB) to the state machine (10), and
selectively feeding said memory (14) with re-programming signals received over said respective input line.

32. The method of claim 31, characterised in that it comprises the step of providing output and state selector (12) having a set of input lines (IS) to the machine (10) and in that said respective input line (EAB) is distinct from said input (IS) lines of said selector (12).

33. The method of claim 22, characterised in that it comprises the step of providing a set of input lines (IS) to the machine (10) at least one line in said set of input lines (IS) being adapted to receive input signals as two bit condition signals whereby said condition can be expressed as a three state signal (1,0,X).

34. The method of claim 27, characterised in that a default transition is provided among states of said number of states, said default transition including said next state as well as the values of said output signals (OS).

35. The method of claim 34, characterised in that it comprises the step of arranging said machine (10). to select said default transition when none of the conditions on the inputs of the other transitions is met.

36. The method of claim 34, characterised in that said machine (10) is executedasd as a Moore machine by causing to each said transition to correspond the output values of said default transition.

37. The method of claim 27, characterised in that it comprises the steps of:
providing a set of input lines (IS) to the machine (10) including a plurality of comparators,
causing each of said comparators to receive input signals as well as one of the possible input configurations described in the state description;
selecting a next state of said number of states as well as the corresponding set of output signals (OS) if one of said comparators provides a positive result, default values being selected in the absence of any such positive result.

38. The method of claim 22, characterised in that it comprises the step of providing a plurality of counters for describing the state machine (10), said counters being external components of said state machine (10) and arranged to communicate with the said state machine (10) by means of at least one of an enable signal and an end-of-count signal.

39. The method of claim 22, characterised in that it comprises the step of providing at least one computational block external with respect to said state machine (10) and arranged to communicate with said state machine (10) by means of at least one signal selected from the group consisting of the signals input to the machine (IS) and the signals output from the machine (OS).

40. The method of claim 38, characterised in that it comprises the steps of:
providing said counters with at least one of a reference value and an end-of-count value, and
modifying run time said at least one of said reference value and said end-of-count value.

41. The method of claim 38, characterised in that it comprises the step of providing at least one re-writable register for contain a reference value for the respective counter.

42. The method of claim 22, characterised in that said memory (14) is chosen as a random access memory (RAM).
